(19) United States
(12) Patent Application Publication
(10) Pub. No.: US 2023/0398724 A1
(43) Pub. Date: Dec. 14, 2023

(54) INJECTION MOLDING MACHINE

(71) Applicant: FANUC CORPORATION, Minamitsuru-gun, Yamanashi (JP)

(72) Inventors: Kazuyoshi TANAKA, Yamanashi (JP); Junpei MARUYAMA, Yamanashi (JP); Tatsuhiro UCHIYAMA, Yamanashi (JP)

(21) Appl. No.: 18/022,636

(22) PCT Filed: Aug. 20, 2021
(86) PCT No.: PCT/JP2021/030603

§ 371 Date: Feb. 22, 2023

(30) Foreign Application Priority Data
Aug. 27, 2020 (JP) 2020-143747

(51) Int. Cl. B29C 45/76; B29C 45/84

(52) U.S. Cl. CPC B29C 45/762; B29C 2945/76939; B29C 45/84

(57) ABSTRACT

An injection molding machine is provided with a selection unit which selects an operation mode from among a plurality of operation modes, a condition acquisition unit which acquires a present condition of the injection molding machine or of peripheral equipment of the injection molding machine, and a determination unit which, based on the selected operation mode and the present condition, determines whether or not manipulation in the operation mode is executable using a plurality of operation initiation conditions pertaining to the operation mode. The injection molding machine is also provided with a display control unit which, when the manipulation in the operation mode is not executable, causes interrelationships between the respective operation initiation conditions pertaining to the operation mode to be displayed in a prescribed display mode on a display unit.

### TECHNICAL FIELD

The present invention relates to an injection molding machine.

### BACKGROUND ART

Conventionally, when starting execution in a prescribed operation mode, an injection molding machine confirms execution initiation conditions (for example, if the position of a movable part corresponds to a prescribed position and the state of a safety gate and peripheral equipment corresponds to a prescribed state). Then, to facilitate confirmation of whether such execution initiation conditions are satisfied, such a method is known that causes a state pertaining to the execution initiation conditions to be displayed on a display device of the injection molding machine using a message, an icon, and the like (for example, see Patent Document 1).

Patent Document 1: Japanese Unexamined Patent Application, Publication No. 2004-255589

### DISCLOSURE OF THE INVENTION

### Problems to be Solved by the Invention

Such an injection molding machine normally has, in many cases in a prescribed operation mode, a plurality of operation initiation conditions relating to each other. In particular, the plurality of operation initiation conditions have relationships equivalent to each other in level or hierarchical relationships. However, to know such relationships, an operator of the injection molding machine needs to master running operations of the injection molding machine. Therefore, such an injection molding machine has been demanded on which it is possible to facilitate the running operations thereof.

### Means for Solving the Problems

An injection molding machine according to the present disclosure includes: a selection unit configured to select an operation mode from among a plurality of operation modes; a state acquisition unit configured to acquire a present state of the injection molding machine or of peripheral equipment of the injection molding machine; a determination unit configured to determine, based on the operation mode selected by the selection unit and the present state of the injection molding machine, or peripheral equipment of the injection molding machine, acquired by the state acquisition unit, whether or not an operation in the operation mode is executable using a plurality of operation initiation conditions pertaining to the operation mode; and a display control unit configured to cause, when the determination unit determines that the operation in the operation mode is not executable, interrelationships between the plurality of operation initiation conditions pertaining to the operation mode to be displayed in a prescribed display mode on a display unit.

### Effects of the Invention

With the present invention, it is possible to facilitate the running operations of an injection molding machine.

### BRIEF DESCRIPTION OF THE DRAWINGS

FIG. 1 is a view illustrating an outline of an injection molding machine according to an embodiment;

FIG. 2 is a flowchart illustrating processing of an ejector advancing operation in a manual mode;

FIG. 3 is a view illustrating a self-diagnostic message window;

FIG. 4 is a view illustrating a layered structure of operation initiation conditions in the ejector advancing operation in the manual mode;

FIG. 5 is a flowchart illustrating processing of a mold closing operation in the manual mode;

FIG. 6 is a view illustrating a self-diagnostic message window;

FIG. 7 is a view illustrating a layered structure of operation initiation conditions in the mold closing operation in the manual mode;

FIG. 8 is a flowchart illustrating processing of an automatic operation initiating operation in a semi-automatic mode;

FIG. 9 is a view illustrating a self-diagnostic message window;

FIG. 10 is a view illustrating a layered structure of operation initiation conditions in the automatic operation initiating operation in the semi-automatic mode;

FIG. 11 is a view illustrating an example when highlighting messages using a character color and underlining;

FIG. 12 is a view illustrating an example when highlighting messages using a character color and a background color;

FIG. 13 is a view illustrating an example when highlighting messages using numbers indicating a layered structure of operation initiation conditions;

FIG. 14 is a view illustrating an example when highlighting messages using a flowchart indicating a layered structure of operation initiation conditions;

FIG. 15 is a view illustrating an interlock condition for performing an ejector advancing operation;

FIG. 16 is a view illustrating an interlock condition for performing a mold opening operation;

FIG. 17 is a view illustrating an interlock condition for performing a mold operation permission confirmation operation; and

FIG. 18 is a view illustrating interlock conditions having a layered structure for performing the ejector advancing operation.

### PREFERRED MODE FOR CARRYING OUT THE INVENTION

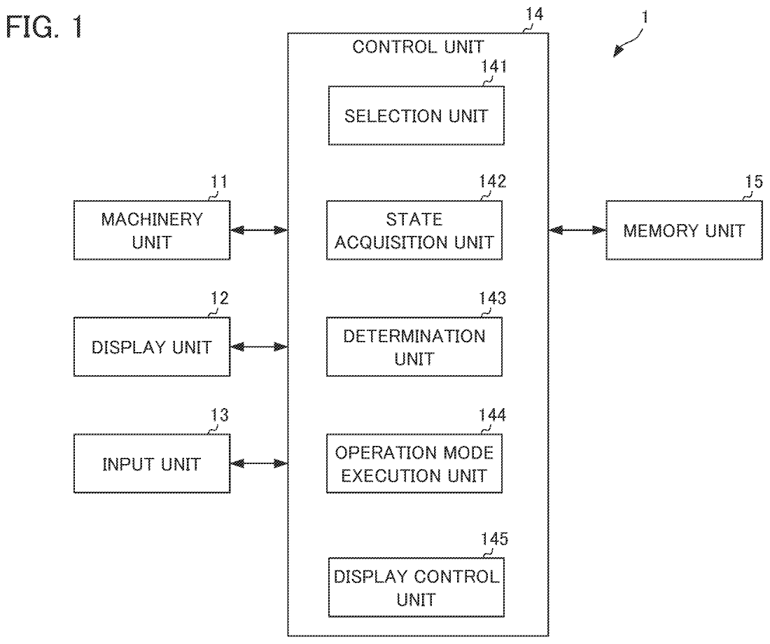

An example of an embodiment of the present invention will now be described herein. FIG. 1 is a view illustrating an outline of an injection molding machine 1 according to an embodiment. As illustrated in FIG. 1, the injection molding machine 1 includes a machinery unit 11, a display unit 12, an input unit 13, a control unit 14, and a memory unit 15.

The machinery unit 11 includes various types of mechanisms, including a safety door, molds, an ejector, a picking device, a controller, a heater, a clamp, and a valve gate, which are configured to perform injection molding in the injection molding machine 1. The machinery unit 11 operates by following a direct operation by an operator or by following control by the control unit 14.

The display unit 12 is constructed based on a liquid crystal display, for example, which is configured to display various types of information. The input unit 13 is constructed based on buttons, keys, switches, and the like, which are configured to accept various types of input operations from the operator. Note that the display unit 12 and the input unit 13 may form a teaching operation panel having an integrated touch panel, for example. Furthermore, the teaching operation panel may be constructed based on a tablet terminal.

The control unit 14 is a processor such as a central processing unit (CPU). The control unit 14 is configured to execute programs stored in the memory unit 15 to execute various types of processing of the injection molding machine 1. Furthermore, the control unit 14 includes a selection unit 141, a state acquisition unit 142, a determination unit 143, an operation mode execution unit 144, and a display control unit 145.

The memory unit 15 represents a storage device including, for example, a read only memory (ROM) storing an operating system (OS), application programs, and other programs, a random access memory (RAM), and a hard disk drive and a solid state drive (SSD) storing various types of information.

The selection unit 141 is configured to select an operation mode from among a plurality of operation modes of the injection molding machine 1. Specifically, the selection unit 141 follows an input via the input unit 13 to select an operation mode from among the plurality of operation modes including an automatic mode, a semi-automatic mode, and a manual mode, for example.

The state acquisition unit 142 is configured to acquire a present state of the injection molding machine 1 or peripheral equipment (not shown) of the injection molding machine 1. Note herein that examples of the present state of the injection molding machine 1 include open and closure of the safety door, advancement and retraction of an ejector mechanism, whether or not a mold operation permission signal for a molded product picking device has been inputted, open and closure of the molds, and the state of a core in the molds. Furthermore, the peripheral equipment includes, for example, the molded product picking device that picks up a molded product from the molds, an insert part insertion device that inserts an insert part into the molds, a mold temperature adjusting device that adjusts the temperature of the molds, a resin drying device that dries a molding material, and a conveyor that conveys the molded product.

The present state of the injection molding machine 1 or the peripheral equipment may be acquired using a limit switch or a proximity sensor, for example, may be acquired by acquiring a present position of a motor mounted with an encoder or by acquiring a numerical value such as an analog input value, or may be acquired using communications.

The determination unit 143 is configured to determine, based on the operation mode selected by the selection unit 141 and the present state of the injection molding machine 1, or the peripheral equipment of the injection molding machine 1, acquired by the state acquisition unit 142, whether or not an operation in the operation mode is executable using a plurality of operation initiation conditions pertaining to the operation mode.

Specifically, the determination unit 143 determines whether or not the present state of the injection molding machine 1 acquired by the state acquisition unit 142 in the operation mode selected by the selection unit 141 satisfies the plurality of operation initiation conditions pertaining to the operation mode to determine whether or not the operation in the operation mode is executable using the plurality of operation initiation conditions pertaining to the operation mode.

For example, in an ejector advancing operation in the manual mode, a plurality of operation initiation conditions pertaining to the manual mode represent four operation initiation conditions including “Safety door has been closed”, “Molds have been opened”, “Operation permission signal for ejector has been inputted”, and “Core-pulling has been completed”.

Then, the determination unit 143 determines that, when the present state of the injection molding machine 1 acquired by the state acquisition unit 142 satisfies all the four operation initiation conditions described above, the ejector advancing operation in the manual mode is executable. On the other hand, the determination unit 143 determines that, when the present state of the injection molding machine 1 acquired by the state acquisition unit 142 does not satisfy at least one of the four operation initiation conditions described above, the ejector advancing operation in the manual mode is not executable.

The operation mode execution unit 144 is configured to execute, when the determination unit 143 determines that the operation in the operation mode is executable, the operation in the operation mode. Specifically, the operation mode execution unit 144 executes, when the determination unit 143 determines that the ejector advancing operation in the manual mode is executable, the ejector advancing operation in the manual mode using the plurality of operation initiation conditions pertaining to the manual mode.

The display control unit 145 is configured to cause, when the determination unit 143 determines that the operation in the operation mode is not executable, interrelationships between the plurality of operation initiation conditions pertaining to the operation mode to be displayed in a prescribed display mode on the display unit 12. The prescribed display mode includes, for example, highlighting information pertaining to a particular operation initiation condition. Note that details of a specific example of the prescribed display mode will be described later.

Furthermore, the memory unit 15 is configured to store beforehand the interrelationships between the plurality of operation initiation conditions. Then, the interrelationships between the plurality of operation initiation conditions include numbers respectively added to the plurality of operation initiation conditions. The numbers respectively added to the plurality of operation initiation conditions may be, for example, numbers such as 1, 2, 3, etc. respectively added to operation initiation conditions at a highest level, which pertain to initiation in the operation mode.

Furthermore, the numbers respectively added to the plurality of operation initiation conditions may be, for example, numbers such as 1-1, 1-2, 1-3, etc. respectively added to operation modes at a lower level, which pertain to initiation in the operation mode.

Furthermore, the interrelationships between the plurality of operation initiation conditions may have a layered structure of the plurality of operation initiation conditions. For example, the interrelationships between the plurality of operation initiation conditions may have a layered structure arranged in an order of degrees of priority of the operation initiation conditions.

Furthermore, the display control unit 145 may highlight, as a prescribed display mode, information pertaining to an operation initiation condition in a deepest layer in the layered structure.

For example, when the interrelationships between the plurality of operation initiation conditions have a layered structure arranged in the order of the degrees of priority of the operation initiation conditions (for example, the higher the layer, the lower the degree of priority, and the lower the layer, the higher the degree of priority), the operation initiation condition in the deepest layer corresponds to an operation initiation condition with a highest degree of priority. Therefore, in this case, the display control unit 145 highlights, as the prescribed display mode, information pertaining to the operation initiation condition in the deepest layer in the layered structure (for example, a message in a self-diagnostic message window). Example modes of highlighting will be described later. Thereby, the operator of the injection molding machine 1 is able to easily know the operation initiation condition with the higher degree of priority.

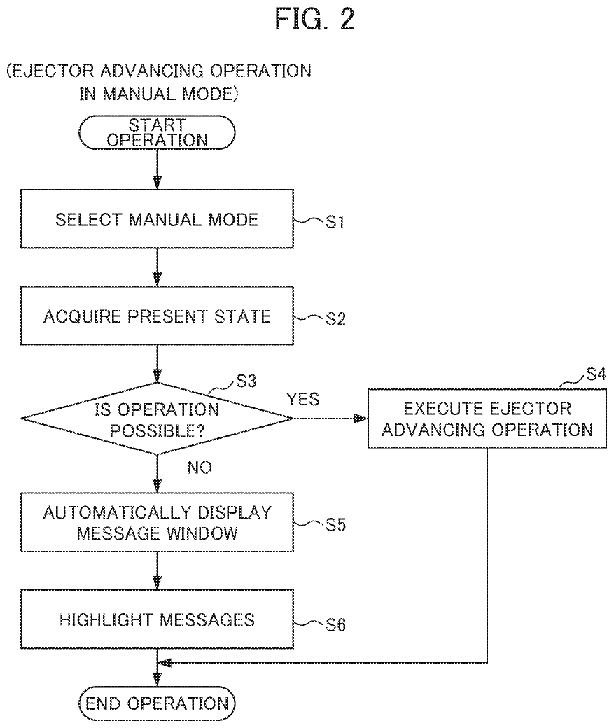

Next, specific processing in each operation mode will now be described below. FIGS. 2 to 4 are views for describing an example of the ejector advancing operation in the manual mode. FIG. 2 is a flowchart illustrating processing of the ejector advancing operation in the manual mode.

At Step S1, the selection unit 141 selects the manual mode from among the plurality of operation modes of the injection molding machine 1. At Step S2, the state acquisition unit 142 acquires a present state of the injection molding machine 1.

At Step S3, the determination unit 143 determines, based on the manual mode selected at Step S1 and the present state of the injection molding machine 1 acquired at Step S2, whether or not the ejector advancing operation in the manual mode is executable using a plurality of operation initiation conditions pertaining to the manual mode. When it is determined that the ejector advancing operation in the manual mode is executable (YES), the processing proceeds to Step S4. When it is determined that the ejector advancing operation in the manual mode is not executable (NO), the processing proceeds to Step S5.

Note herein that, in the ejector advancing operation in the manual mode, the plurality of operation initiation conditions pertaining to the manual mode correspond to, for example, four operation initiation conditions including “Safety door has been closed”, “Molds have been opened”, “Operation permission signal for ejector has been inputted”, and “Core-pulling has been completed”.

Then, the determination unit 143 determines that, when the present state of the injection molding machine 1 acquired by the state acquisition unit 142 satisfies all the four operation initiation conditions described above, the ejector advancing operation in the manual mode is executable. On the other hand, the determination unit 143 determines that, when the present state of the injection molding machine 1 acquired by the state acquisition unit 142 does not satisfy at least one of the four operation initiation conditions described above, the ejector advancing operation in the manual mode is not executable.

At Step S4, the operation mode execution unit 144 executes the ejector advancing operation in the manual mode using the plurality of operation initiation conditions pertaining to the manual mode. At Step S5, the display control unit 145 causes a self-diagnostic message window M1 to be displayed on the display unit 12, indicating the present state of the injection molding machine 1, interrelationships between the plurality of operation initiation conditions pertaining to the manual mode, and other types of information.

At Step S6, the display control unit 145 highlights, as a prescribed display mode, messages pertaining to the ejector advancing operation in the self-diagnostic message window M1.

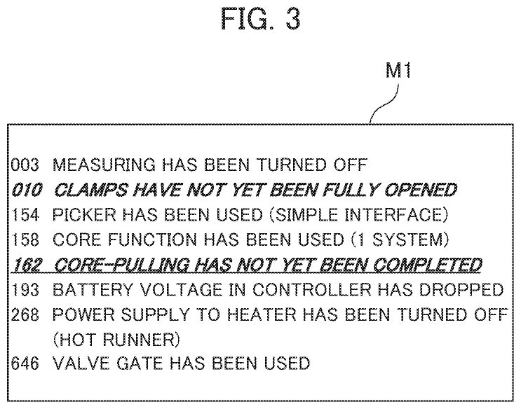

FIG. 3 is a view illustrating the self-diagnostic message window M1. As illustrated in FIG. 3, the display control unit 145 highlights, in the self-diagnostic message window M1, a message “Clamps have not yet been fully opened” indicated by a message number 010 and a message “Core-pulling has not yet been completed” indicated by a message number 162.

Specifically, the display control unit 145 highlights the operation initiation conditions by changing the color of the messages indicated by the message numbers 010 and 162 (note that, for purpose of convenience, in FIG. 3, the messages are indicated in italicized font, instead of changing the color of the messages). Furthermore, the message indicated by the message number 162 corresponds to an operation necessary for releasing interlocking due to the message number 010, and also to an operation initiation condition with a highest degree of priority. Therefore, the display control unit 145 not only changes the color of the message indicated by the message number 162, but also highlights the message indicated by the message number 162 through underlining.

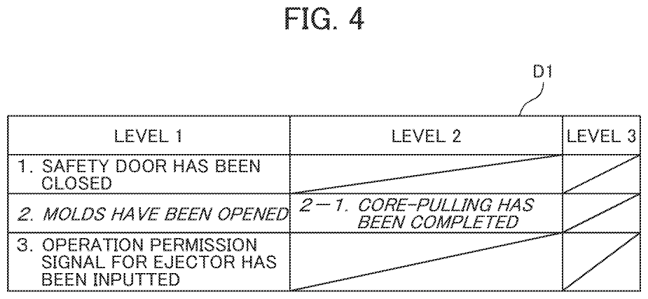

FIG. 4 is a view illustrating a layered structure D1 of the operation initiation conditions in the ejector advancing operation in the manual mode. Note that the operation initiation conditions indicated in italicized font in FIG. 4 correspond to operation initiation conditions that have not yet been satisfied.

In FIG. 4, a level indicates a depth in the layered structure D1 of the operation initiation conditions. That is, the layered structure D1 becomes deeper in the order of Level 1, Level 2, and Level 3.

Furthermore, in the layered structure D1 illustrated in FIG. 4, the operation initiation condition “2. Molds have been opened” corresponds to the message “Clamps have not yet been fully opened” indicated by the message number 010 illustrated in FIG. 3, while the operation initiation condition “2-1. Core-pulling has been completed” corresponds to the message “Core-pulling has not yet been completed” indicated by the message number 162 illustrated in FIG. 3.

Then, in the layered structure D1, the operation initiation condition “2-1. Core-pulling has been completed” is necessary for releasing interlocking due to the operation initiation condition “2. Molds have been opened”. Therefore, the operation initiation condition “2-1. Core-pulling has been completed” is deeper in the layered structure than the operation initiation condition “1. Molds have been opened”, and the degree of priority of which is thus set higher.

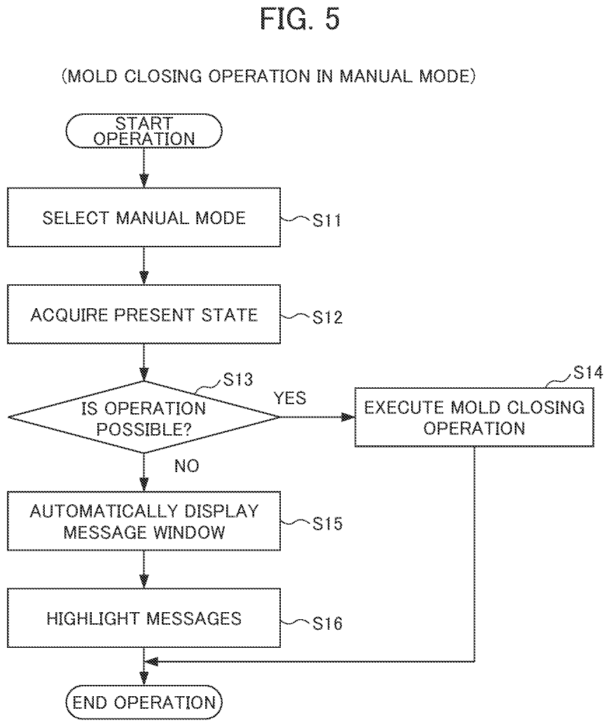

FIGS. 5 to 7 are views for describing an example of a mold closing operation in the manual mode. FIG. 5 is a flowchart illustrating processing of the mold closing operation in the manual mode.

At Step S11, the selection unit 141 selects the manual mode from among the plurality of operation modes of the injection molding machine 1. At Step S12, the state acquisition unit 142 acquires a present state of the injection molding machine 1.

At Step S13, the determination unit 143 determines, based on the manual mode selected at Step S11 and the present state of the injection molding machine 1 acquired at Step S12, whether or not the mold closing operation in the manual mode is executable using a plurality of operation initiation conditions pertaining to the manual mode. When it is determined that the mold closing operation in the manual mode is executable (YES), the processing proceeds to Step S14. When it is determined that the mold closing operation in the manual mode is not executable (NO), the processing proceeds to Step S15.

Note herein that, in the mold closing operation in the manual mode, the plurality of operation initiation conditions pertaining to the manual mode correspond to, for example, four operation initiation conditions including “Safety door has been closed”, “Ejector has been retracted”, “Mold operation permission signal for molded product picking device has been inputted”, and “Operation permission signal for ejector has been inputted”.

Then, the determination unit 143 determines that, when the present state of the injection molding machine 1 acquired by the state acquisition unit 142 satisfies all the four operation initiation conditions described above, the mold closing operation in the manual mode is executable. On the other hand, the determination unit 143 determines that, when the present state of the injection molding machine 1 acquired by the state acquisition unit 142 does not satisfy at least one of the four operation initiation conditions described above, the mold closing operation in the manual mode is not executable.

At Step S14, the operation mode execution unit 144 executes the mold closing operation in the manual mode using the plurality of operation initiation conditions pertaining to the manual mode. At Step S15, the display control unit 145 causes a self-diagnostic message window M2 to be displayed on the display unit 12, indicating the present state of the injection molding machine 1, interrelationships between the plurality of operation initiation conditions pertaining to the manual mode, and other types of information.

At Step S16, the display control unit 145 highlights, as a prescribed display mode, a message pertaining to the mold closing operation in the self-diagnostic message window M2.

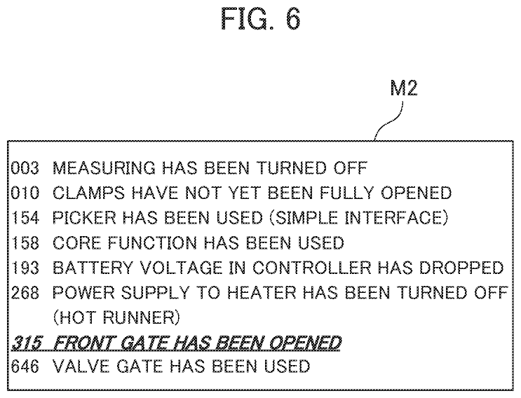

FIG. 6 is a view illustrating the self-diagnostic message window M2. As illustrated in FIG. 6, the display control unit 145 highlights a message “Front gate has been opened” indicated by a message number 315 in the self-diagnostic message window M2.

Specifically, the display control unit 145 causes the message indicated by the message number 315 to be displayed by changing the color. Furthermore, the message indicated by the message number 315 corresponds to an operation initiation condition with a highest degree of priority. Therefore, the display control unit 145 not only changes the color of the message indicated by the message number 315, but also highlights the message indicated by the message number 315 through underlining.

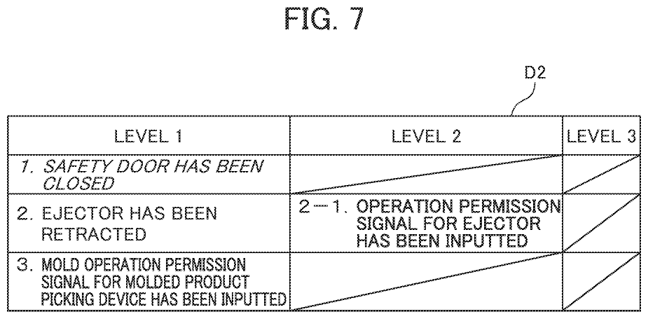

FIG. 7 is a view illustrating a layered structure D2 of the operation initiation conditions in the mold closing operation in the manual mode. In FIG. 7, a level indicates a depth in the layered structure D2 of the operation initiation conditions. That is, the layered structure D2 becomes deeper in the order of Level 1, Level 2, and Level 3.

Furthermore, in the layered structure D2 illustrated in FIG. 7, an operation initiation condition “1. Safety door has been closed” corresponds to the message “Front gate has been opened” indicated by the message number 315 illustrated in FIG. 6.

Then, as illustrated in FIG. 7, the operation initiation condition “1. Safety door has been closed”, only which is not satisfied presently in the layered structure D2, is indicated in italicized font.

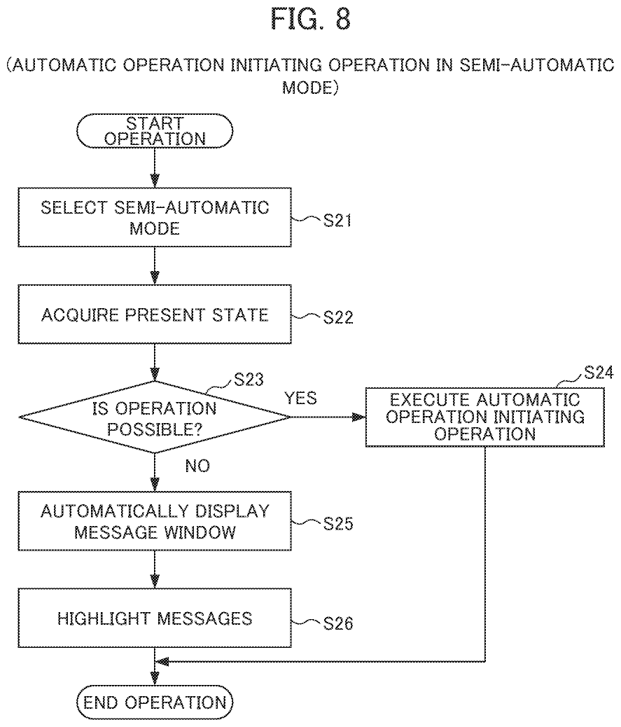

FIGS. 8 to 10 are views for describing an example of an automatic operation initiating operation in the semi-automatic mode. FIG. 8 is a flowchart illustrating processing of the automatic operation initiating operation in the semi-automatic mode.

At Step S21, the selection unit 141 selects the semi-automatic mode from among the plurality of operation modes of the injection molding machine 1. At Step S22, the state acquisition unit 142 acquires a present state of the injection molding machine 1.

At Step S23, the determination unit 143 determines, based on the semi-automatic mode selected at Step S21 and the present state of the injection molding machine 1 acquired at Step S22, whether or not the automatic operation initiating operation in the semi-automatic mode is executable using a plurality of operation initiation conditions pertaining to the semi-automatic mode. When it is determined that the automatic operation initiating operation in the semi-automatic mode is executable (YES), the processing proceeds to Step S24. When it is determined that the automatic operation initiating operation in the semi-automatic mode is not executable (NO), the processing proceeds to Step S25.

Note herein that, in the automatic operation initiating operation in the semi-automatic mode, the plurality of operation initiation conditions pertaining to the semi-automatic mode correspond to, for example, five operation initiation conditions including “Molds have been opened”, “Heater has been turned ON”, “Safety door has been closed”, “Core-pulling has been completed”, and “Mold operation permission signal for molded product picking device has been inputted”.

Then, the determination unit 143 determines that, when the present state of the injection molding machine 1 acquired by the state acquisition unit 142 satisfies all the five operation initiation conditions described above, the automatic operation initiating operation in the semi-automatic mode is executable. On the other hand, the determination unit 143 determines that, when the present state of the injection molding machine 1 acquired by the state acquisition unit 142 does not satisfy at least one of the five operation initiation conditions described above, the automatic operation initiating operation in the semi-automatic mode is not executable.

At Step S24, the operation mode execution unit 144 executes the automatic operation initiating operation in the semi-automatic mode using the plurality of operation initiation conditions pertaining to the semi-automatic mode. At Step S25, the display control unit 145 causes a self-diagnostic message window M3 to be displayed on the display unit 12, indicating the present state of the injection molding machine 1, interrelationships between the plurality of operation initiation conditions pertaining to the manual mode, and other types of information.

At Step S26, the display control unit 145 highlights, as a prescribed display mode, messages pertaining to the automatic operation initiating operation in the self-diagnostic message window M3.

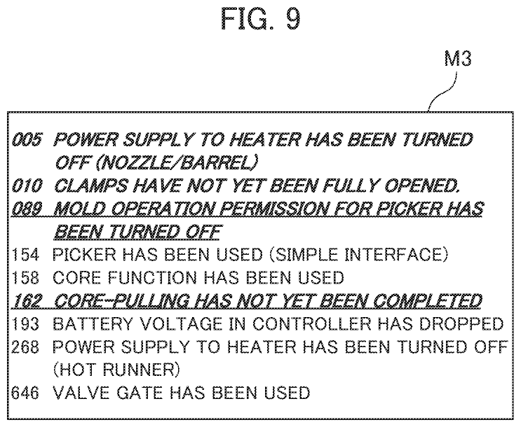

FIG. 9 is a view illustrating the self-diagnostic message window M3. As illustrated in FIG. 9, the display control unit 145 highlights, in the self-diagnostic message window M3, a message “Power supply to heater has been turned off (nozzle/barrel)” indicated by a message number 005, the message “Clamps have not yet been fully opened” indicated by the message number 010, a message “Mold operation permission for picker has been turned OFF” indicated by a message number 089, and the message “Core-pulling has not yet been completed” indicated by the message number 162.

Specifically, the display control unit 145 causes the messages indicated by the message numbers 005, 010, 089, and 162 to be displayed by changing the color (note that, in FIG. 9, the messages are indicated in italicized font, instead of changing the color of the messages).

Furthermore, the messages indicated by the message numbers 089 and 162 correspond to operations necessary for releasing interlocking due to the message number 010, and also to operation initiation conditions with a highest degree of priority. Therefore, the display control unit 145 not only changes the color of the messages indicated by the message numbers 089 and 162, but also highlights the messages indicated by the message numbers 089 and 162 through underlining.

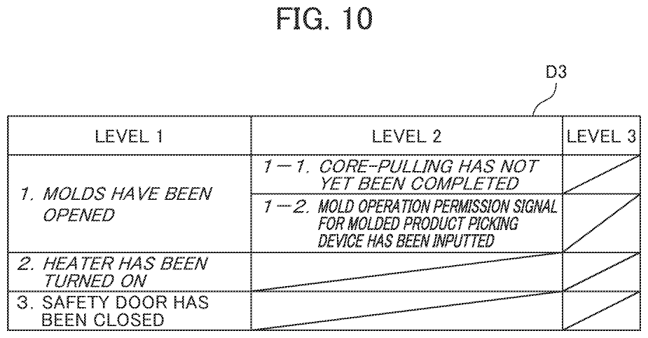

FIG. 10 is a view illustrating a layered structure D3 of the operation initiation conditions in the automatic operation initiating operation in the semi-automatic mode. Note that the operation initiation conditions indicated in italicized font in FIG. 10 correspond to operation initiation conditions that have not yet been satisfied.

In FIG. 10, a level indicates a depth in the layered structure D3 of the operation initiation conditions. That is, the layered structure D3 becomes deeper in the order of Level 1, Level 2, and Level 3.

Furthermore, in the layered structure D3 illustrated in FIG. 10, the operation initiation condition “1. Molds have been opened” corresponds to the message “Clamps have not yet been fully opened” indicated by the message number 010 illustrated in FIG. 9, while the operation initiation condition “1-1. Core-pulling has been completed” corresponds to the message “Core-pulling has not yet been completed” indicated by the message number 162 illustrated in FIG. 9.

Furthermore, the operation initiation condition “1-2. Mold operation permission signal for molded product picking device has been inputted” corresponds to the message “Mold operation permission for picker has been turned OFF” indicated by the message number 089 illustrated in FIG. 9, while the operation initiation condition “2. Heater has been turned ON” corresponds to the message “Power supply to heater has been turned off (nozzle/barrel)” indicated by the message number 005 illustrated in FIG. 9.

Then, in the layered structure D3, the operation initiation conditions “1-1. Core-pulling has been completed” and “1-2. Mold operation permission signal for molded product picking device has been inputted” are necessary for releasing interlocking due to the operation initiation condition “1. Molds have been opened”. Therefore, the operation initiation conditions “1-1. Core-pulling has been completed” and “1-2. Mold operation permission signal for molded product picking device has been inputted” are deeper in the layered structure than the operation initiation condition “1. Molds have been opened”, and the degree of priority of which is thus set higher.

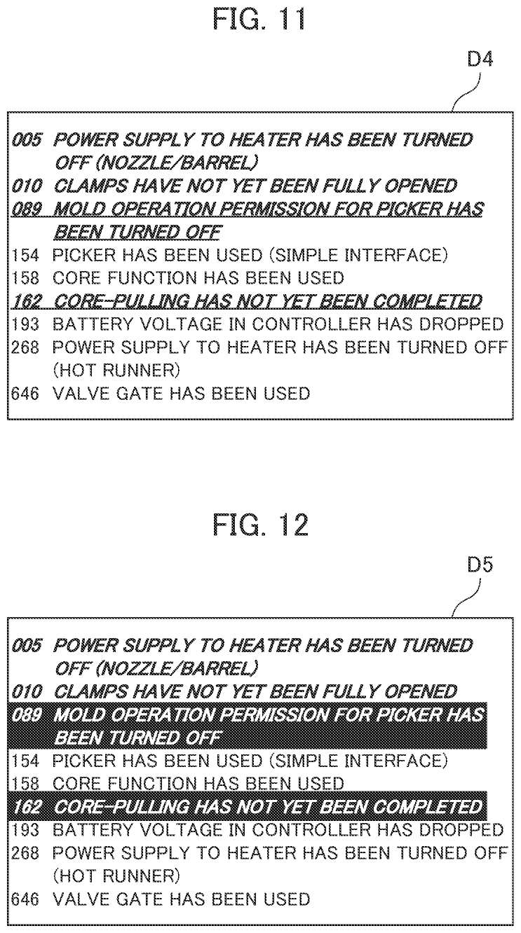

FIGS. 11 to 14 are views illustrating examples of highlighting by the display control unit 145. FIG. 11 is a view illustrating an example when highlighting messages using a character color and underlining, similar to FIGS. 3, 6, and 9. As illustrated in FIG. 11, the display control unit 145 highlights the messages indicated by the message numbers 005, 010, 089, and 162 in a self-diagnostic message window D4 by changing the color of the messages (note that, in FIGS. 11 and 12, the messages are indicated in italicized font, instead of changing the color of the messages).

Furthermore, the messages indicated by the message numbers 089 and 162 correspond to operations necessary for releasing interlocking due to the message number 010, and also to operation initiation conditions with a highest degree of priority. Therefore, the display control unit 145 not only changes the color of the messages indicated by the message numbers 089 and 162, but also highlights the messages indicated by the message numbers 089 and 162 through underlining. Thereby, the character color and underlining of the messages allow the operator of the injection molding machine 1 to easily know the operation initiation conditions with a higher degree of priority.

FIG. 12 is a view illustrating an example when highlighting messages using a character color and a background color. As illustrated in FIG. 12, the display control unit 145 highlights the messages indicated by the message numbers 005, 010, 089, and 162 in a self-diagnostic message window D5 by changing the color of the messages.

Furthermore, the display control unit 145 highlights the messages by not only changing the color of the messages indicated by the message numbers 089 and 162, but also changing the background color of the messages indicated by the message numbers 089 and 162. Thereby, the character color and the background color of the messages allow the operator of the injection molding machine 1 to easily know the operation initiation conditions with a higher degree of priority.

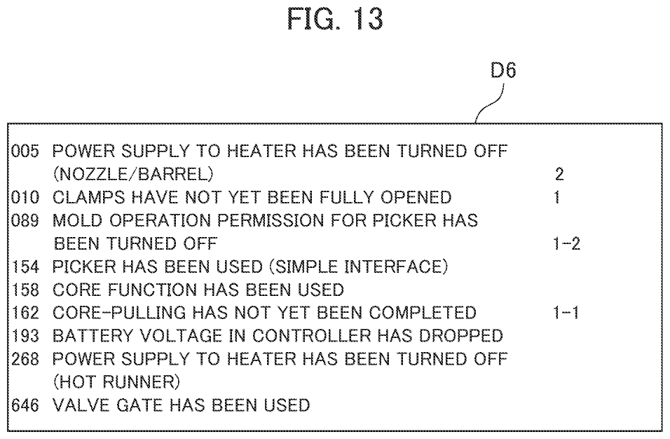

FIG. 13 is a view illustrating an example when highlighting messages using numbers indicating a layered structure of operation initiation conditions. As illustrated in FIG. 13, the display control unit 145 highlights the messages indicated by the message numbers 005, 010, 089, and 162 in a self-diagnostic message window D6 by adding numbers indicating a layered structure of operation initiation conditions to the messages.

More specifically, a number “1” is added to the message indicated by the message number 010, a number “2” is added to the message indicated by the message number 005, a number “1-1” is added to the message indicated by the message number 162, and a number “1-2” is added to the message indicated by the message number 089.

Then, the operation initiation conditions corresponding to the messages to which the numbers “1-1” and “1-2” have been added respectively are necessary for releasing interlocking due to the operation initiation conditions corresponding to the message to which the number “1” has been added. As described above, such numbers indicating a layered structure of operation initiation conditions allow the operator of the injection molding machine 1 to easily know operation initiation conditions with a higher degree of priority.

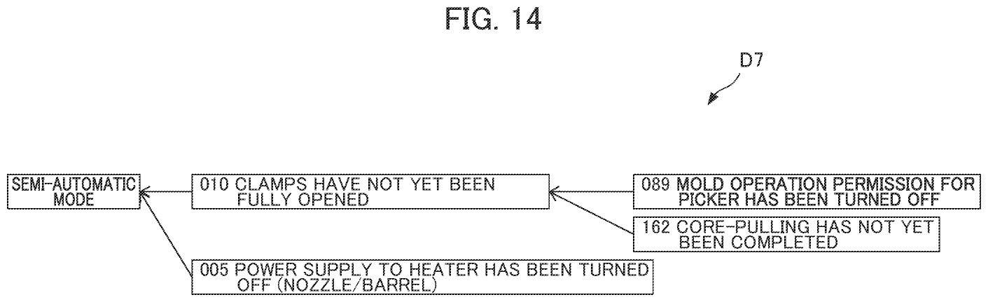

FIG. 14 is a view illustrating an example when highlighting messages using a flowchart D7 indicating a layered structure of operation initiation conditions. As illustrated in FIG. 14, the display control unit 145 causes the flowchart D7 to be displayed, indicating the layered structure of the operation initiation conditions corresponding to the messages indicated by the message numbers 005, 010, 089, and 162.

Thereby, the operator of the injection molding machine 1 is able to know that the operation initiation conditions corresponding to the message numbers 089 and 162 are necessary for releasing interlocking due to the operation initiation condition corresponding to the message number 010.

Furthermore, the operator of the injection molding machine 1 is able to know that the operation initiation conditions corresponding to the message numbers 005 and 010 are necessary for releasing interlocking due to the operation initiation conditions for executing the semi-automatic mode. These messages may represent a layered structure in the form of a table as illustrated in FIG. 4, 7, or 10.

Next, conditions for releasing interlocking due to operation initiation conditions will now be described below. To perform an operation in an operation mode in the injection molding machine 1, interlock conditions for releasing interlocking for the operation differs depending on the type of molds.

Specifically, it is possible to change, by the control unit 14, whether advancement of the ejector is enabled only in a state where opening of molds has been completed and whether the picking device is used, among the interlock conditions. For example, when the picking device is not used and when the mold opening operation is to be performed, it is not necessary to confirm whether a mold operation permission signal has come ON.

However, urging the operator to create, per a set of molds, a table of interlock conditions having a layered structure that differs per the set of molds and to cause the memory unit 15 to store the created table beforehand is not practical, as it requires many tables of interlock conditions. Then, the injection molding machine 1 causes interlock conditions having a layered structure as described below to be dynamically displayed.

Specifically, the control unit 14 first sets a completed state for each operation in each of the plurality of operation modes. When an operation is in an uncompleted state, the display control unit 145 causes a message to be displayed on the display unit 12, indicating that the operation is in the uncompleted state.

Furthermore, the control unit 14 defines, for the operation, interlock conditions that enable the operation. Note herein that the interlock conditions include completed states that are set for other operations.

The interlock conditions defined for the first time correspond to those at Level 1 illustrated in FIG. 4, 7, or 10. From the initially set conditions for the display control unit 145, the interlock conditions at Level 1 are known. For each operation, the display control unit 145 calculates information in which a completed state, messages, and interlock conditions are combined with each other. The display control unit 145 regards this information as operation information at Level 1.

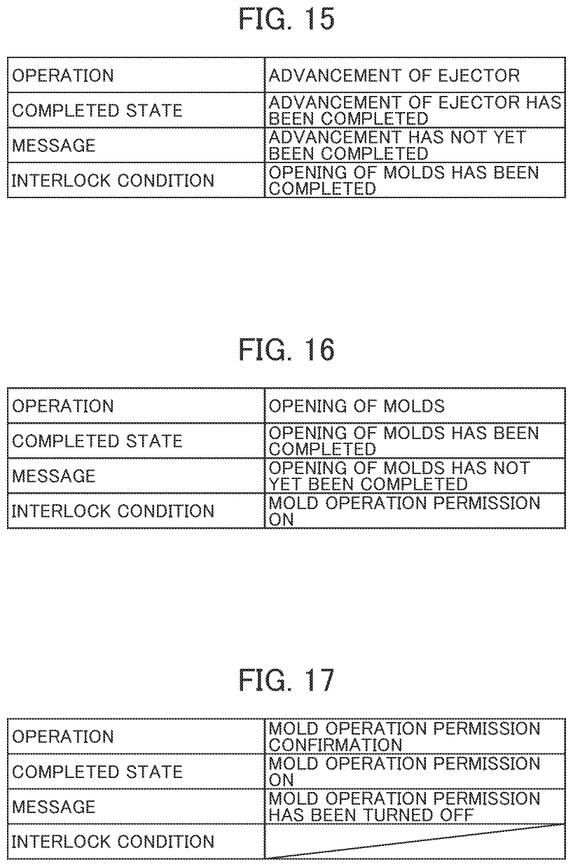

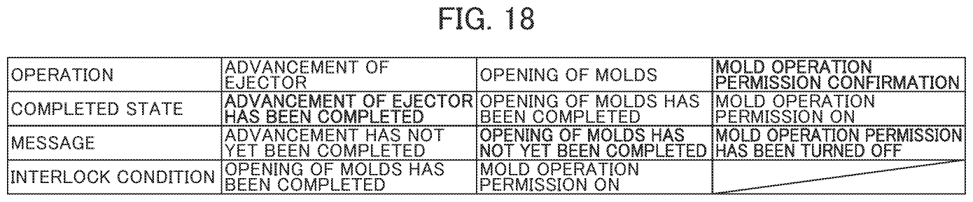

FIG. 15 is a view illustrating an interlock condition for performing an ejector advancing operation. FIG. 16 is a view illustrating an interlock condition for performing the mold opening operation. FIG. 17 is a view illustrating an interlock condition for performing a mold operation permission confirmation operation. FIG. 18 is a view illustrating interlock conditions having a layered structure for performing an ejector advancing operation.

Furthermore, the interlock condition illustrated in FIG. 15 represents operation information at Level 1 for performing the ejector advancing operation. The interlock condition illustrated in FIG. 16 represents operation information at Level 1 for performing the mold opening operation. The interlock condition illustrated in FIG. 17 represents operation information at Level 1 for performing the mold operation permission confirmation operation. The interlock conditions illustrated in FIG. 18 are generated by linking the interlock conditions pertaining to the operation information at Level 1 illustrated in FIGS. 15 to 17 and the operations to each other.

As illustrated in FIG. 18, the interlock condition for performing the ejector advancing operation requires the state where opening of molds has been completed. Therefore, the display control unit 145 is able to generate a layered structure for interlocking, to which the mold opening operation set with a condition that opening of molds has been completed as the completed state is combined. Then, the interlock condition for performing the mold opening operation requires a condition that mold operation permission has come ON. Therefore, the display control unit 145 generates a layered structure for interlocking, to which mold operation permission confirmation set with a condition that mold operation permission has come ON as the completed state is combined. Generation of the layered structure is completed at a stage when an operation to which no interlock conditions have been set or an operation for which no set messages have been displayed is combined.

Note herein that, when there are still other interlock conditions for performing the ejector advancing operation illustrated in FIG. 15, other than the condition that opening of molds has been completed, a plurality of layered structures for interlocking will be generated.

That is, to perform the ejector advancing operation, the injection molding machine 1 is required to perform operations in the order of the mold operation permission confirmation, the mold opening operation, and the ejector advancing operation. Then, the display control unit 145 causes, for example, messages to be displayed on the display unit 12, which correspond to the mold operation permission confirmation, the mold opening operation, and the ejector advancing operation, to which numbers indicating the order of the operations are added.

As described above, to perform each operation in an operation mode, the display control unit 145 dynamically generates interlock conditions having a layered structure for releasing interlocking for the operation, and causes the interlock conditions to be displayed on the display unit 12. Thereby, the injection molding machine 1 is able to flexibly display different interlock conditions in accordance with the type of a set of molds.

As described above, according to the present embodiment, the injection molding machine 1 includes: the selection unit 141 configured to select an operation mode from among a plurality of operation modes; the state acquisition unit 142 configured to acquire a present state of the injection molding machine 1; the determination unit 143 configured to determine, based on the operation mode selected by the selection unit 141 and the present state of the injection molding machine 1 acquired by the state acquisition unit 142, whether or not an operation in the operation mode is executable using a plurality of operation initiation conditions pertaining to the operation mode; and the display control unit 145 configured to cause, when the determination unit 143 determines that the operation in the operation mode is not executable, interrelationships between the plurality of operation initiation conditions pertaining to the operation mode to be displayed in a prescribed display mode on the display unit 12.

Thereby, the injection molding machine 1 causes the interrelationships between the plurality of operation initiation conditions pertaining to the operation mode to be displayed on the display unit 12. Therefore, the operator of the injection molding machine 1 is able to fully know the contents of the operation initiation conditions by viewing the interrelationships between the plurality of operation initiation conditions pertaining to the operation mode, which are displayed on the display unit 12, making it possible to facilitate running operations of the injection molding machine 1.

Furthermore, the injection molding machine 1 further includes the operation mode execution unit 144 configured to execute, when the determination unit 143 determines that the operation in the operation mode is executable, the operation in the operation mode using the plurality of operation initiation conditions pertaining to the operation mode. Thereby, the injection molding machine 1 is able to appropriately execute the operation in the operation mode.

Furthermore, the injection molding machine 1 further includes the memory unit 15 configured to store beforehand the interrelationships between the plurality of operation initiation conditions. Thereby, the injection molding machine 1 is able to appropriately use the interrelationships between the plurality of operation initiation conditions, which are stored in the memory unit 15.

Furthermore, the interrelationships between the plurality of operation initiation conditions include numbers respectively added to the plurality of operation initiation conditions. Thereby, the numbers respectively added to the plurality of operation initiation conditions allow the operator of the injection molding machine 1 to easily know, for example, degrees of priority of the operation initiation conditions.

Furthermore, the interrelationships between the plurality of operation initiation conditions have a layered structure including the plurality of operation initiation conditions. Thereby, the operator of the injection molding machine 1 is able to easily know, for example, the degrees of priority of the operation initiation conditions.

Furthermore, the display control unit 145 highlights, as a prescribed display mode, information pertaining to an operation initiation condition in the deepest layer in the layered structure. Thereby, when an operation initiation condition in the deepest layer corresponds to an operation initiation condition with a highest degree of priority, for example, the operator of the injection molding machine 1 is able to easily know the operation initiation condition with the highest degree of priority.

Although the embodiment of the present invention has been described above, it is possible to achieve the injection molding machine 1 described above through hardware, software, or combinations thereof. Furthermore, it is also possible to achieve a control method that is to be implemented by the injection molding machine 1 described above through hardware, software, or combinations thereof. In here, achievement through software means achievement when a computer reads and executes programs.

It is possible to use a non-transitory computer readable medium that varies in type to store the programs, and to supply the programs to a computer. Examples of the non-transitory computer readable medium include tangible storage media that vary in type. Examples of the non-transitory computer readable medium include magnetic recording media (for example, hard disk drive), magneto-optical recording media (for example, magneto-optical disc), compact disc read only memories (CD-ROM), compact disc-recordable (CD-R), compact disc-rewritable (CD-R/W), semiconductor memories (for example, mask ROM, programmable ROM (PROM), erasable PROM (EPROM), flash ROM, and random access memory (RAM)).

Furthermore, although the foregoing embodiment represents a preferable embodiment of the present invention, the scope of the present invention should not be limited to only the embodiment described above. Embodiments that have been variously changed without departing from the gist of the present invention are also implementable.

### EXPLANATION OF REFERENCE NUMERALS

1 Injection molding machine
11 Machinery unit
12 Display unit
13 Input unit
14 Control unit
15 Memory unit
141 Selection unit
142 State acquisition unit
143 Determination unit
144 Operation mode execution unit
145 Display control unit

1. An injection molding machine comprising:
a selection unit configured to select an operation mode from among a plurality of operation modes;
a state acquisition unit configured to acquire a present state of the injection molding machine or of peripheral equipment of the injection molding machine;
a determination unit configured to determine, based on the operation mode selected by the selection unit and the present state of the injection molding machine or of peripheral equipment of the injection molding machine, acquired by the state acquisition unit, whether or not an operation in the operation mode is executable using a plurality of operation initiation conditions pertaining to the operation mode; and
a display control unit configured to cause, when the determination unit determines that the operation in the operation mode is not executable, interrelationships between the plurality of operation initiation conditions pertaining to the operation mode to be displayed in a prescribed display mode on a display unit.

2. The injection molding machine according to claim 1, further comprising an operation mode execution unit configured to execute, when the determination unit determines that the operation in the operation mode is executable, the operation in the operation mode using the plurality of operation initiation conditions pertaining to the operation mode.

3. The injection molding machine according to claim 1, further comprising a memory unit configured to store beforehand the interrelationships between the plurality of operation initiation conditions.

4. The injection molding machine according to claim 1, wherein the interrelationships between the plurality of operation initiation conditions include numbers respectively added to the plurality of operation initiation conditions.

5. The injection molding machine according to claim 1, wherein the interrelationships between the plurality of operation initiation conditions have a layered structure including the plurality of operation initiation conditions.

6. The injection molding machine according to claim 5, wherein the display control unit highlights, as the prescribed display mode, information pertaining to an operation initiation condition in a deepest layer in the layered structure.
